(19) United States
(12) Patent Application Publication
(10) Pub. No.: US 2026/0057498 A1
(43) Pub. Date: Feb. 26, 2026

(54) IMAGE DISTORTION CORRECTION DEVICE AND IMAGE DISTORTION CORRECTION METHOD ABLE TO INCREASE PROCESSING EFFICIENCY

(71) Applicant: SigmaStar Technology Ltd., Xiamen (CN)

(72) Inventor: Yu Jie QIU, Shanghai (CN)

(21) Appl. No.: 19/227,620

(22) Filed: Jun. 4, 2025

(30) Foreign Application Priority Data
Aug. 22, 2024 (CN) 202411161441.X

(51) Int. Cl. G06T 5/80; G06T 5/50

(52) U.S. Cl. CPC G06T 5/80; G06T 5/50

(57) ABSTRACT

An image distortion correction device includes an interpolation range preprocessing circuit, a memory, a first register set, a control circuit and a pixel processing circuit. The interpolation range preprocessing circuit obtains a plurality of first mapping points according to a mapping table, and determines a first pixel set according to the plurality of first mapping points. The memory stores input image data. The control circuit determines whether the input image data includes first set data corresponding to the first pixel set, and stores the first set data to the first register set when the input image data includes the first set data. The pixel processing circuit performs distortion correction according to the first set data in the first register set to generate a plurality of sets of output pixel data, and accordingly generates output image data.

This application claims the benefit of China application Serial No. CN202411161441.X, filed on Aug. 22, 2024, the subject matter of which is incorporated herein by reference.

### BACKGROUND OF THE INVENTION

### Field of the Invention

The present application relates to an image distortion correction device, and more particularly to an image distortion correction device and an image distortion correction method able to increase processing efficiency.

### Description of the Related Art

An existing image distortion correction device usually performs correction in a pixel-by-pixel manner; that is, the image distortion correction device is able to generate only corrected data of one pixel in each round of distortion correction. Moreover, a large capacity of a static random access memory (SRAM) is needed to store original image data or an SRAM needs to be repeatedly read to obtain sufficient original image data during the distortion correction. Thus, degraded overall efficiency and a large circuit area are resulted.

### SUMMARY OF THE INVENTION

In some embodiments, it is an object of the present application to provide an image distortion correction device and an image distortion correction method able to increase processing efficiency so as to improve the issues of the prior art.

In some embodiments, an image distortion correction device includes an interpolation range preprocessing circuit, a memory, a first register set, a control circuit and a pixel processing circuit. The interpolation range preprocessing circuit obtains a plurality of first mapping points according to a mapping table, and determines a first pixel set according to the plurality of first mapping points. The memory stores input image data. The control circuit determines whether the input image data includes first set data corresponding to the first pixel set, and stores the first set data to the first register set when the input image data includes the first set data. The pixel processing circuit performs distortion correction according to the first set data in the first register set to generate a plurality of sets of output pixel data, and accordingly generates output image data.

In some embodiments, an image distortion correction method performed by an image distortion correction device includes operations of: obtaining a plurality of first mapping points according to a mapping table, and determining a first pixel set according to the plurality of first mapping points; determining whether input image data in a memory of the image distortion correction device includes first set data corresponding to the first pixel set, and storing the first set data to a first register set of the image distortion correction device when the input image data includes the first set data; and performing distortion correction according to the first set data in the first register set to generate a plurality of sets of output data, and accordingly generating output image data.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of an image distortion correction device according to some embodiments of the present application.

FIG. 2 is a schematic diagram of correspondence among the input image data, mapping table and output image data in FIG. 1 according to some embodiments of the present application.

FIG. 3 is a flowchart of main operations of the image distortion correction device in FIG. 1 according to some embodiments of the present application.

FIG. 4 is an operation flowchart of pipelined operations of the image distortion correction device in FIG. 1 according to some embodiments of the present application.

FIG. 5 is an operation flowchart of an image distortion correction method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

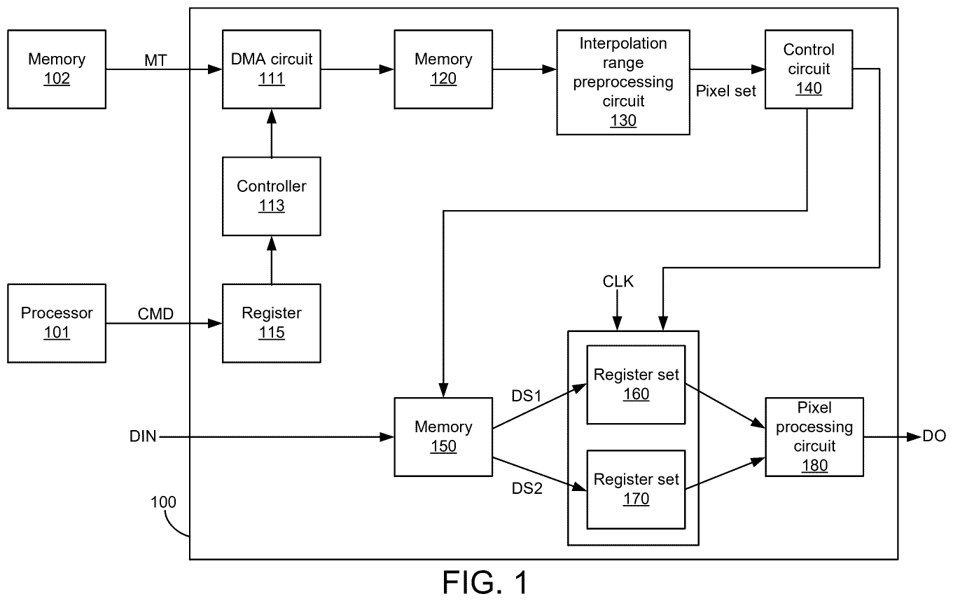

FIG. 1 shows a schematic diagram of an image distortion correction device 100 according to some embodiments of the present application. The image distortion correction device 100 includes a direct memory access (DMA) circuit 111, a controller 113, a register 115, a memory 120, an interpolation range preprocessing circuit 130, a control circuit 140, a memory 150, a register set 160, a register set 170 and a pixel processing circuit 180.

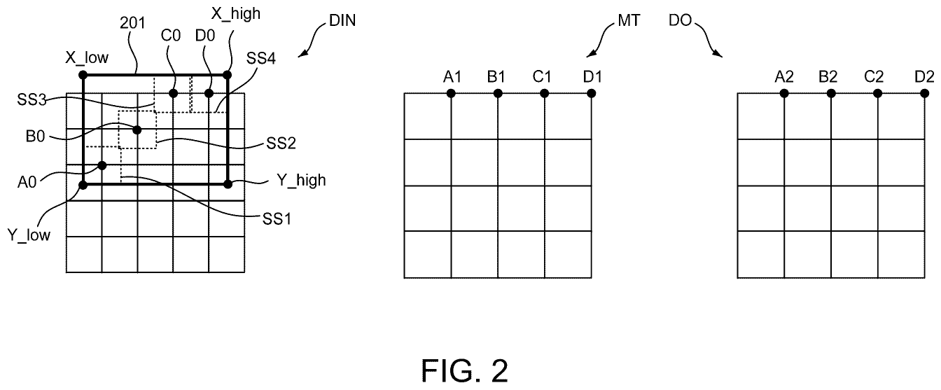

A processor 101 may execute image processing software to issue a correction command CMD to the register 115 to configure one or more control parameters in the register 115, so as to activate the image distortion correction device 100. In response to the correction command CMD, the memory 150 may store input image data DIN until the storage space of the memory 150 is fully used. In some embodiments, the input image data DIN may be from a dynamic random access memory (DRAM, not shown) or from an image processing circuit (not shown). In some embodiments, the memory 150 may be, for example but not limited to, a static random access memory (SRAM). Meanwhile, the controller 113 may configure the DMA circuit 111 according to the one or more control parameters in the register 115, allowing the DMA circuit 111 to write a mapping table MT from the memory 102 to the memory 120. In some embodiments, the memory 102 may be, for example but not limited to, a DRAM. In some embodiments, the mapping table MT is for indicating correspondence between pixels of the input image data DIN and output image data DO. In some embodiments, the mapping table MT may be provided by a manufacturer of a lens that generates the input image data DIN; however, the present application is not limited to the example above. Details associated with the mapping table MT are to be described with reference to FIG. 2 below.

The interpolation range preprocessing circuit 130 obtains multiple first mapping points (for example, the mapping points A1, B1, C1 and D1 in FIG. 2) according to the mapping table MT, and determines a first pixel set (for example, the pixel set 201 in FIG. 2) according to the multiple first mapping points. In some embodiments, the interpolation range preprocessing circuit 130 may determine, according to an interpolation operation in an image distortion correction algorithm, multiple pixels in the input image data DIN for generating multiple pixels of the first mapping points, and set the first pixel set according to positions of these pixels. In some embodiments, the image distortion correction algorithm may be a lens distortion correction algorithm. In some embodiments, the interpolation operation may be, for example but not limited to, a bicubic interpolation operation. Details associated with the first mapping points and the pixel set are to be described with reference to FIG. 2 below.

The control circuit 140 determines whether the input image data DIN in the memory 150 includes set data DS1 corresponding to the first pixel set above. In some embodiments, the set data DS1 includes image information of all pixels in the first pixel set. If the input image data DIN in the memory 150 includes the set data DS1, the control circuit 140 may store the set data DS1 from the memory 150 to the register set 160. If the input image data DIN in the memory 150 does not include the set data DS1, the control circuit 140 may wait until the set data DS1 is stored in the memory 150 and then write the set data DS1 from the memory 150 to the register set 160. In some embodiments, the controller circuit 140 may be implemented by a microcontroller or a digital processing circuit; however, the present application is not limited to the examples above.

The pixel processing circuit 180 performs distortion correction according to the set data DS1 in the register set 160 to generate multiple output pixel data (for example, image information of multiple output pixels A2, B2, C2 and D2 in FIG. 2), and accordingly generates the output image data DO. For example, after all output pixel data in the output image data has been generated, the pixel processing circuit 180 may combine the output pixel data, and output the combined output pixel data as the output image data DO. In some embodiments, the pixel processing circuit 180 may be implemented by a processing circuit able to execute an image distortion correction algorithm; however, the present application is not limited to the example above.

FIG. 2 shows a schematic diagram of correspondence among the input image data DIN, the mapping table MT and the output image data DO in FIG. 1 according to some embodiments of the present application. As shown in FIG. 2, the input image data DIN may be an image possibly containing image distortion, and the output image data DO is an output image having undergone image distortion correction. In general, in a situation where mounting positions and angles of a sensor and a lens that generate an image are fixed, the degree of image distortion of the input image data DIN generated by the sensor is substantially constant. Thus, with operations and measurement carried out in advance, the correspondence between the positions of pixels in the input image data generated by the senor and the lens and the positions of pixels in the corrected output image data DO can be obtained.

For example, assume that the number of multiple output pixel data that the pixel processing circuit 180 can generate by performing one round of distortion correction is 4 (that is, the pixel processing circuit 180 can process 4 pixels at a time). The multiple output pixels A2, B2, C2 and D2 in the output image data DO respectively correspond to the multiple mapping points A1, B1, C1 and D1 in the mapping table MT. With the calculation of the interpolation range preprocessing circuit 130, it can be determined that the multiple mapping points A1, B1, C1 and D1 respectively correspond to multiple pixels A0, B0, C0 and D0 in the input image data DIN and that the multiple pixels A0, B0, C0 and D0 respectively correspond to multiple interpolation regions SS1, SS2, SS3 and SS4. In the input image data DIN, multiple pixels (including the pixel A0) in the interpolation region SS1 may be used to interpolate image information of the output pixel A2 (that is, one of the output pixel data). Similarly, in the input image data DIN, multiple pixels (including the pixel B0) in the interpolation region SS2 may be used to interpolate image information of the output pixel B2 (that is, one set of output pixel data). Accordingly, the correspondence among the multiple interpolation regions SS1 to SS4, the multiple pixels A0, B0, C0 and D0, the multiple mapping points A1, B1, C1 and D1, and the multiple output pixels A2, B2, C2 and D2 can be obtained. In some embodiments, the number of pixels in each of the multiple interpolation regions SS1, SS2, SS3 and SS4 is determined according to the number of original pixels that the image distortion correction algorithm needs for correcting one pixel. For example but not limited to, the number of original pixels may be 4*4 pixels.

Thus, the interpolation range preprocessing circuit 130 may obtain multiple mapping points from the mapping table MT according to a sequence (for example but not limited to, one row after another), and obtain multiple corresponding pixels in the input image data DIN and respective multiple interpolation regions according to these mapping points. Next, the interpolation range preprocessing circuit 130 may set the pixel set 201 according to these interpolation regions. For example, the upper-rightmost position of the multiple interpolation regions SS1 to SS4 is the coordinate X_high, the lower-rightmost position is the coordinate Y_high, the lower-leftmost position is the coordinate Y_low, and the corresponding upper-leftmost position is the coordinate X_low. The interpolation range preprocessing circuit 130 may set a region formed by the coordinate X_high, the coordinate X_low, the coordinate Y_high and the coordinate Y_low as the pixel set 201 (which covers the multiple interpolation regions SS1 to SS4).

In some embodiments, the set data DS1 is the image information of all pixels of the input image data DIN located in the pixel set 201. The control circuit 140 may determine whether the input image data DIN stored to the memory 150 includes the set data DS1. If so, the control circuit 140 may write the set data DS1 from the memory 150 to the register set 160, such that the pixel processing circuit 180 may obtain the set data DS1 from the register set 160 and perform distortion correction according to the set data DS1 to generate multiple output pixel data (that is, the image information of the multiple output pixels A2, B2, C2 and D2).

In some embodiments, each of the register set 160 and the register set 170 includes multiple registers (not shown), and the number of these registers may be determined according to a first value and a second value, wherein the first value is the number of the output pixel data that the pixel processing circuit 180 can generate by performing distortion correction once (taking the example in FIG. 2 for instance, the first value is 4), and the second value is the number of pixels, in the input image data DIN, used for generating one of the multiple output pixel data. For example, as described above, the number of the multiple interpolation regions SS1, SS2, SS3 and SS4 may be 4*4 pixels, that is, the second value is 16 (4*4). In this case, the number of the registers may be N*M, where the value N may be less than or equal to a product (that is, 4*4) of a factor between the first value and the second value, and the value M may be less than or equal to a product (that is, 4*4) of the other factor between the first value and the second value. With the setting of the multiple registers above, it can be ensured that the data capacity of each of the register set 160 and the register set 170 is sufficient for storing the image information of all original pixels that the pixel processing circuit 180 needs for performing one round of distortion correction. Thus, the pixel processing circuit 180 can quickly obtain all image information needed for performing distortion correction from the register set 160 (and/or the register set 170), so as to more efficiently generate multiple output pixel data.

On the other hand, because the pixel processing circuit 180 obtains the multiple image information (for example, the set data DS1) to be corrected from the register set 160 (and/or the register set 170) but does not read the set data DS1 from the memory 150, the pixel processing circuit 180 can quickly obtain the set data DS1 within an extremely short period of time. For example, the register set 160 and the register set 170 are first-in-first-out (FIFO) data buffers operable according to a clock signal CLK, and may be triggered according to the clock signal CLK to receive and/or output data. In some embodiments, the pixel processing circuit 180 may obtain the set data DS1 within one clock cycle of the clock signal CLK.

In some related art, a distortion correction circuit obtains image data to be corrected from an SRAM to generate one of the corrected output pixel data. Since a distortion correction algorithm needs multiple original pixel data for interpolation to generate the corrected output pixel data, a distortion correction circuit is required to read from the SRAM multiple times in order to obtain the multiple original pixel data, resulting in degraded processing efficiency. Alternatively, in some related art, a greater number of SRAMs are used to store multiple original pixel data in the aim of increasing data transmission efficiency. However, the approach above leads to an overly large circuit area and increased overall production costs. Different from the related art discussed above, in some embodiments of the present application, the interpolation range preprocessing circuit 130 may read multiple mapping points (that is, at least two output pixel data can be generated each time) according to the mapping table MT, the register set 160 (and/or the register set 170) may store corresponding set data in the input image data DIN in advance, and the pixel processing circuit 180 obtains multiple image information (for example, the set data DS1) to be corrected from the register set 160 (and/or the register set 170), wherein the data capacity of each of the register set 160 and the register set 170 is set in accordance with the correction ability of the pixel processing circuit 180. Thus, data transmission efficiency and distortion correction efficiency can be increased while a certain number of registers are used without increasing the number of SRAMs used, and so overall production costs can then be saved.

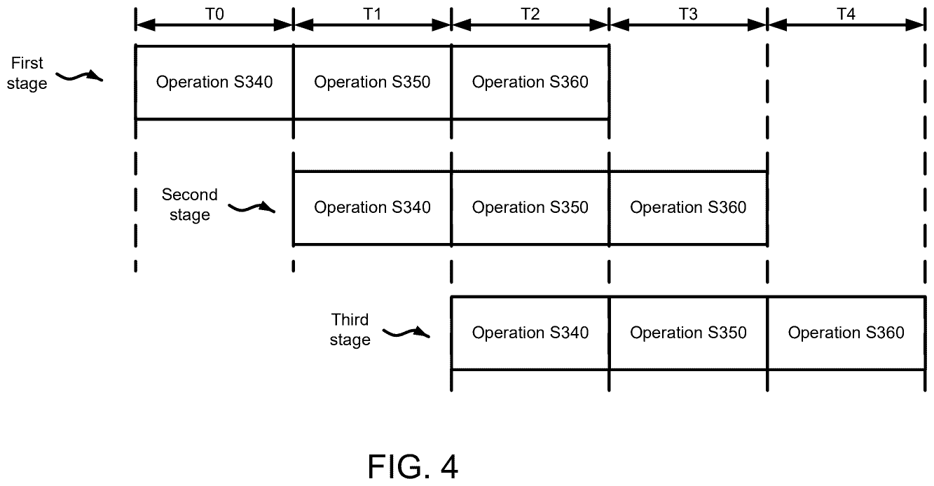

In some embodiments, the register set 170 can store set data (for example, the set data DS2) corresponding to other mapping points in different operation periods, so as to collaborate with the register set 160 to jointly perform pipelined continuous operations. As such, overall processing efficiency can be increased. Details associated with the configuration herein are to be described with reference to FIG. 4 below.

In some embodiments, the control circuit 140 may further determine whether a data size of the set data DS1 exceeds the data capacity of the register set 160. If so, the control circuit 140 may store partial data of the set data DS1 from the memory 150 to the register set 160, and a data size of the partial data is less than or equal to the data capacity of the register set 160. As such, the pixel processing circuit 180 may perform distortion correction according to the partial data to generate partial pixel data in the multiple output pixel data. If not, the control circuit 140 may store the entire set data DS1 from the memory 150 to the register set 160.

For example, when the data size of the set data DS1 exceeds the data capacity of the register set 160, the control circuit 140 may configure related parameters in the register set 160, so as to reduce the number of sets of output pixel data that the pixel processing circuit 180 generates (for example, reducing the multiple output pixel A2, B2, C2 and D2 to the multiple output pixel A2 and B2) by performing the current round of distortion correction. Meanwhile, the control circuit 140 may output, in the set data DS1 in the memory 150, pixel data in the interpolation regions SS1 and SS2 corresponding to the multiple pixels A2 and B2 as the partial data above, and store the partial data to the register set 160. As such, the pixel processing circuit 180 may obtain the partial data from the register set 160, and accordingly generate the multiple output pixel data corresponding to the multiple output pixels A2 and B2.

In some embodiments, during the process above, the control circuit 140 may further configure related parameters in the register set 160 (and/or the register set 170) to indicate corresponding positions of output pixels currently being processed. Thus, in a next operation, the control circuit 140 may resume processing of output pixels yet to be generated, so as to subsequently read remaining data in the set data DS1 read from the memory 150 (or to merge as next set of data). As such, the pixel processing circuit 180 may resume generating of the remaining multiple output pixel data to generate the output image data DO.

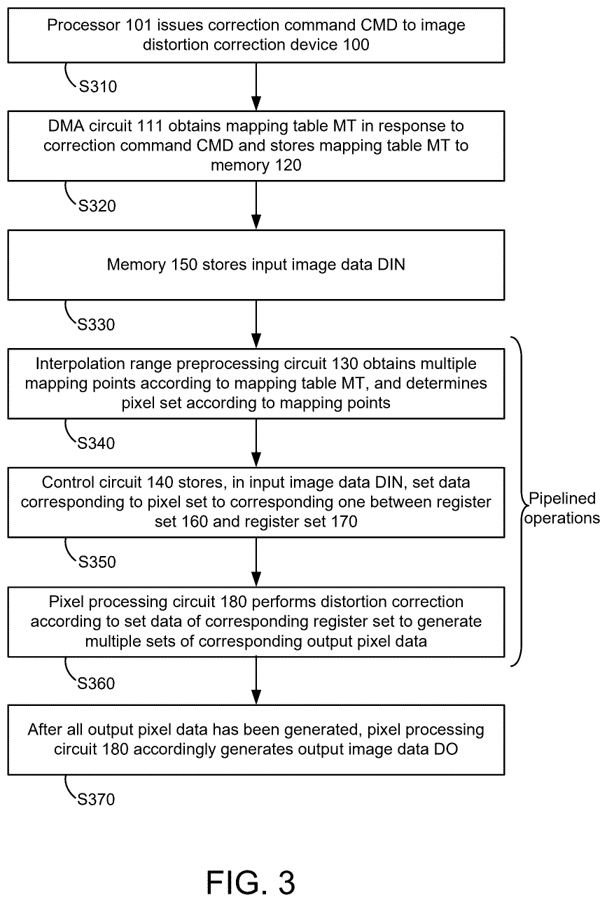

FIG. 3 shows a flowchart of main operations of the image distortion correction device 100 in FIG. 1 according to some embodiments of the present application. In operation S310, the processor 101 issues the correction command CMD to the image distortion correction device 100. In operation S320, the DMA circuit 111 obtains the mapping table MT from the memory 102 in response to the correction command CMD, and stores the mapping table MT to the memory 120. In operation S330, the memory 150 stores the input image data DIN. In operation S340, the interpolation range preprocessing circuit 130 obtains multiple mapping points according to the mapping table MT, and determines a pixel set according to the mapping points. In operation S350, the control circuit 140 stores the set data corresponding to the pixel set in the input image data DIN from the memory 150 to the corresponding one between the register set 160 and the register set 170. In operation S360, the pixel processing circuit 180 performs distortion correction on the set data of the corresponding register set to generate corresponding multiple output pixel data. In operation S370, after all of the output pixel data has been generated, the pixel processing circuit 180 accordingly generates the output image data DO.

In the process above, operation S340, operation S350 and operation S360 are multiple operations performed consecutively in a pipelined manner. The image distortion correction device 100 may sequentially generate multiple output pixel data by repeating the operations above, until all image distortion in the input image data DIN has been corrected. Details of the pipelined operations above are to be described with reference to FIG. 4 below.

FIG. 4 shows an operation flowchart of the pipelined operations of the image distortion correction device 100 in FIG. 1 according to some embodiments of the present application. As described above, the image distortion correction device 100 may perform the pipelined operations by configuring the multiple register set 160 and register set 170, hence further increasing overall processing efficiency. For example, as shown in FIG. 4, the multiple operations of the image distortion correction device 100 may be divided into operations of multiple stages.

In the operation of the first stage, the image distortion correction device 100 may perform operation S340, operation S350 and operation S360 in FIG. 3 in a period T0, a period T1 and a period T2, respectively, wherein the operations in the first stage are based on the multiple first mapping points in the mapping table MT.

Similarly, in the operation of the second stage, the image distortion correction device 100 may perform operation S340, operation S350 and operation S360 in FIG. 3 in the period T1, the period T2 and the period T3, respectively, wherein the operations in the second stage are based on the multiple second mapping points in the mapping table MT. In other words, in the period T1, when the control circuit 140 writes the set data DS1 from the memory 150 to the register set 160 (that is, operation S350 in the first stage), the interpolation range preprocessing circuit 130 may simultaneously obtain multiple second mapping points according to the mapping table MT, and determine a second pixel set according to the second mapping points (that is, operation S340 in the second stage), wherein the second pixel set is different from the first pixel set corresponding to the multiple first mapping points. Similarly, in the period T2, when the pixel processing circuit 180 performs distortion correction according to the set data DS1 to generate multiple corresponding output pixel data (that is, operation S360 in the first stage), the control circuit 140 may determine whether the input image data DIN in the memory 150 includes second set data corresponding to the second pixel set, and store the second set data to the other register set 170 when the input image data DIN includes the second set data (that is, operation S350 in the second stage).

In the operation of the third stage, the image distortion correction device 100 may again perform operation S340, operation S350 and operation S360 in FIG. 3 in the period T2, the period T3 and a period T4, respectively. Similarly, in the period T2, the interpolation range preprocessing circuit 130 may further simultaneously obtain multiple third mapping points according to the mapping table MT, and determine a third pixel set according to the third mapping points (operation S340 in the third stage). In the period T3, when the pixel processing circuit 180 performs distortion correction according to the second set data to generate corresponding multiple output pixel data (that is, operation S360 in the second stage), the control circuit 140 may further determine whether the input image data DIN in the memory 150 includes third set data corresponding to the third pixel set, and store the third set data to the register set 160 when the input image data DIN includes the third set data (that is, operation S350 in the third stage). Accordingly, the circuits in the image distortion correction device 100 can perform pipelined operations of multiple stages according to the mapping table MT in multiple periods, so as to continuously process the pixel data to be corrected in the input image data DIN to thereby efficiently generate the output image data DO.

Each of the original pixel data, the set data and/or the output pixel data above may include luminance data (that is, Y component data) and chrominance data (that is, U component data and V component data). Depending on actual application requirements, in different embodiments, luminance data and chrominance data may be respectively stored in different memories, or be stored in different spaces of a same memory.

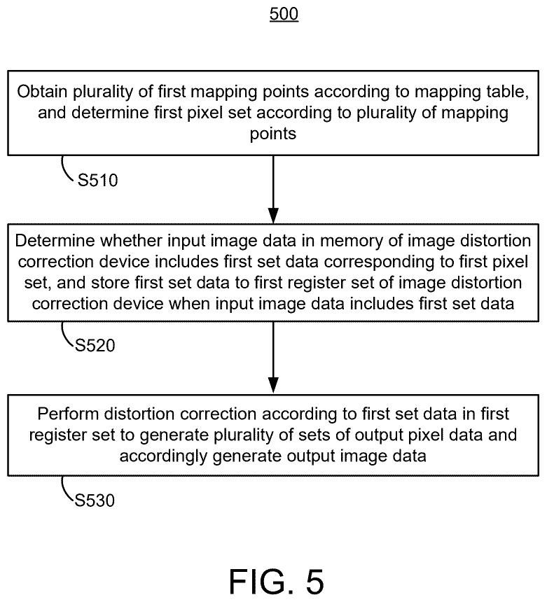

FIG. 5 shows an operation flowchart of an image distortion correction method 500 according to some embodiments of the present application. In some embodiments, the image distortion correction method 500 may be performed by, for example but not limited to, the image distortion correction device 100 in FIG. 1.

In operation S510, a plurality of first mapping points are obtained according to a mapping table, and a first pixel set is determined according to the plurality of first mapping points. In operation S520, it is determined whether input image data in a memory of the image distortion correction device includes first set data corresponding to the first pixel set, and the first set data is stored to a first register set of the image distortion correction device when the input image data includes the first set data. In operation S530, distortion correction is performed according to the first set data in the first register set to generate a plurality of sets of output pixel data, and output image data is generated accordingly.

Details associated with the multiple operations of the image distortion correction method 500 above can be referred from the details of the multiple embodiments above, and such repeated details are omitted herein. The multiple operations above are merely examples, and are not limited to being performed in the order specified in this example. Without departing from the operation means and ranges of the various embodiments of the present application, additions, replacements, substitutions or omissions may be made to the operations of the image distortion correction method 500, or the operations may be performed in different orders. Alternatively, all or some of one or more the operations in the image distortion correction method 500 may be performed simultaneously.

In conclusion, the image distortion correction device and the image distortion correction method provided according to some embodiments of the present application are able to generate a plurality of sets of output pixel data in one round of distortion correction, read required original pixel data from a memory in advance, and perform pipelined operations by means of using multiple register sets. Thus, without using an overly large amount of SRAM, overall distortion correction efficiency can be increased and overall costs can be saved.

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. An image distortion correction device, comprising:
an interpolation range preprocessing circuit, obtaining a plurality of first mapping points according to a mapping table, and determining a first pixel set according to the plurality of first mapping points;
a memory, storing input image data;
a first register set;
a control circuit, determining whether the input image data in the memory comprises first set data corresponding to the first pixel set, and storing the first set data to the first register set when the input image data comprises the first set data; and
a pixel processing circuit, performing distortion correction according to the first set data in the first register set to generate a plurality of output pixel data, and accordingly generating output image data.

2. The image distortion correction device according to claim 1, wherein the control circuit further determines whether a data size of the first set data exceeds a data capacity of the first register set, and stores partial data of the first set data to the first register set when the data size of the first set data exceeds the data capacity of the first register set, wherein a data size of the partial data is less than or equal to the data capacity of the first register set.

3. The image distortion correction device according to claim 2, wherein when the data size of the first set data exceeds the data capacity of the first register set, the pixel processing circuit further performs the distortion correction according to the partial data to generate partial pixel data in the plurality of output pixel data.

4. The image distortion correction device according to claim 1, wherein the first register set comprises a plurality of registers, and the number of the plurality of registers is determined according to a first value and a second value, the first value is the number of the plurality of output pixel data that the pixel processing circuit generates by performing the distortion correction once, and the second value is the number of pixels for generating one of the plurality of output pixel data in the input image data.

5. The image distortion correction device according to claim 1, wherein the interpolation range preprocessing circuit identifies, from the input image data according to the plurality of first mapping points, a plurality of pixels for interpolating the plurality of output pixel data, and sets the first pixel set according to positions of the plurality of pixels.

6. The image distortion correction device according to claim 1, wherein the pixel processing circuit obtains the first set data from the first register set within a clock cycle.

7. The image distortion correction device according to claim 1, wherein when the control circuit writes the first set data from the memory to the first register set, the interpolation range preprocessing circuit obtains a plurality of second mapping points according to the mapping table and determines a second pixel set according to the plurality of second mapping points.

8. The image distortion correction device according to claim 7, wherein the first pixel set is different from the second pixel set.

9. The image distortion correction device according to claim 1, further comprising:
a second register set, wherein when the pixel processing circuit performs the distortion correction according to the first set data to generate the plurality of output pixel data, the control circuit determines whether the input image data in the memory comprises second set data corresponding to a second pixel set and stores the second set data to the second register set when the input image data comprises the second set data, and the second set data corresponds to data of the second pixel set determined by the plurality of second mapping points obtained by the interpolation range preprocessing circuit according to the mapping table.

10. An image distortion correction method, performed by an image distortion correction device, the image distortion correction method comprising:
obtaining a plurality of first mapping points according to a mapping table, and determining a first pixel set according to the plurality of first mapping points;
determining whether input image data in a memory of the image distortion correction device comprises first set data corresponding to the first pixel set, and storing the first set data to a first register set of the image distortion correction device when the input image data comprises the first set data; and
performing distortion correction according to the first set data in the first register set to generate a plurality of output pixel data, and accordingly generating output image data.
